(19) United States
(12) Patent Application Publication
(10) Pub. No.: US 2015/0154154 A1
(43) Pub. Date: Jun. 4, 2015

(54) SYSTEM AND METHOD FOR IMPLEMENTING AN XML STYLESHEET IN A MULTI-TIER ARCHITECTURE

(71) Applicant: MUNBO SOFTWARE PTY LTD, Sydney (AU)

(72) Inventors: Angelo Doukas, Sydney New South Wales (AU); Stephen Gregan, Sydney, New South Wales (AU)

(21) Appl. No.: 14/402,873

(22) PCT Filed: May 31, 2013
(86) PCT No.: PCT/AU2013/000573

§ 371 Date: Nov. 21, 2014

(30) Foreign Application Priority Data
May 31, 2012 (AU) 2012902314

(51) Int. Cl. G06F 17/22

(52) U.S. Cl. CPC G06F 17/227

(57) ABSTRACT

A method for implementing an XML stylesheet in a multi-tiered architecture, the method comprising: retrieving an XML stylesheet associated with a page to be rendered on a presentation interface; and implementing the XML stylesheet to facilitate XML messaging between different logic layers of the multi-tiered architecture for carrying out one or more logic functions associated with the rendered page.

### FIELD OF THE INVENTION

The present invention relates generally to a method for implementing stylesheets. More particularly it relates to a framework and methodology for multi-tier architecture applications through such implementation.

### BACKGROUND OF THE INVENTION

The dramatic changes in computer processing power that have taken place during the past fifty or so years has been evident to most people. However, the evolution of business application architectures, although equally profound, has been far less evident. This evolution can be grouped into three distinct eras: the Mainframe era, the Personal Computer era and the Internet era.

In the Mainframe era, large centrally-located computers such as mainframes executed business rules expressed within programs, managed the storage and retrieval of data and assembled the screens that were displayed by dumb terminals acting like TV sets. Applications in this era had a simple two-tier architecture in which a dumb terminal (the first tier) was connected directly to the mainframe (the second tier) with a connection that always remained open (a “persistent connection” or “session”). Keeping these connections permanently open during a session absorbed part of the mainframe's processing power and placed a limit on the mainframe's ability to scale.

In the Personal Computer era, dumb terminals on the desktop were replaced with personal computers (PCs) that, unlike dumb terminals, had processing power. Client/server architectures were introduced that shifted the processing load from the mainframe (the “server”) to each individual PC (the “client”), relegating the mainframe to a data storage device or database server. Although applications in this era required more sophisticated communication between the mainframe and PC, client/server architecture remained two-tier with a persistent connection.

The third and current era is the Internet era. The introduction of the internet, and the astonishing explosion of web sites, would not have been possible without the creation of a third tier—the web server. Essentially, this third tier sits between the other two tiers (this is why it is usually referred to as the “middle layer”) and manages the connection between the PC (now referred to as the “presentation Layer”) and the database server (the “database server” layer).

The introduction of this third tier has had profound consequences for application architectures, the most important being the introduction of a non-persistent or “stateless” connection. In essence, the web-server is responsible for establishing a temporary connection between the PC and database server that only exists for the period of time taken for the PC's request to be satisfied. This results in far less overhead on the back-end server and scalability that could not have been dreamt of with a two-tier, persistent connection architecture.

In addition, a stateless connection enables the web server to create a connection (temporary though it may be) between the PC and any other server connected to the Internet. This capability in turn is made possible by the use of “browsers” on each PC, such as Windows Internet Explorer® or Firefox®, whose job it is to simply display painting instructions received from web-sites around the world in a standard format (HTML). Ironically, the requirement for browsers has meant that one consequence of the Internet era has been to shift processing power away from the PC and back to special-duty servers. Programs containing business knowledge are now located either in the middle layer or on the database server itself.

Clearly, the Internet era has introduced enormous benefits in scalability (stateless connections) and connectivity (effortless connection to any web server on the Internet). These benefits, however, have come at a cost. The effort required to build three-tiered applications that can execute in the cloud is far greater than the effort required to build two-tiered applications, with most of this extra effort lying in the Presentation layer.

Although freely available HTML-based browsers such as Windows Internet® Explorer and Firefox® have made the Internet possible, they are inherently limited in what they can do. Developers routinely get around these limitations by including with the HTML instructions code written in a scripting language, such as Java script, unavoidably (a) complicating the construction of the presentation layer; and (b) degrading performance.

### SUMMARY OF THE INVENTION

In accordance with a first aspect of the present invention there is provided a method for implementing an XML stylesheet in a multi-tier architecture, the method comprising:
retrieving an XML stylesheet associated with a page to be rendered on a presentation interface;
implementing the XML stylesheet to facilitate XML messaging between different logic layers of the architecture for carrying out one or more logic functions associated with the rendered page.

In an embodiment the method further comprises implementing the XML stylesheet to provide page content for rendering by the presentation interface.

In an embodiment the method further comprises implementing the XML stylesheet to determine a presentation layout for the page content.

In an embodiment the XML stylesheet is served to the presentation interface by a web server which stores the XML stylesheet.

In an embodiment the method further comprises implementing the XML stylesheet to facilitate XML messaging between a presentation layer, middle layer and data layer of the web server architecture.

In an embodiment the XML stylesheet is implemented in the presentation layer by the presentation interface to initiate XML messaging between the different layers for retrieving and/or updating data from/in a database, responsive to a predefined user interaction with the rendered page.

In an embodiment the method further comprises implementing the XML stylesheet to recognise the predefined user interaction and, in response thereto, instruct the presentation interface to generate an XML server request message for processing by a server in order to retrieve/update the data.

In an embodiment the XML server request message is operable to cause the server to invoke business logic which is implemented in the data layer for retrieving and/or updating the data.

In an embodiment the XML server request message is operable to cause the server to invoke business logic which is implemented by a server operating in the middle layer for retrieving and/or updating the data.

In an embodiment the server is configured to assemble data retrieved as a result of the invoked business logic in an XML server response message which is sent back to the presentation interface for re-rendering the page.

In an embodiment the XML server request/response messages are routed by way of a web server.

In an embodiment the method further comprises extracting authentication information from the XML server request message for authentication by the server prior to invoking the business logic.

In accordance with a second aspect of the present invention there is provided a server operable in a multi-tier architecture and comprising a stylesheet serving module configured to serve an XML stylesheet to a presentation interface responsive to receiving a request message from the presentation interface, the presentation interface being operable to implement the XML stylesheet in order to facilitate XML messaging between different logic layers of the architecture for carrying out one or more logic functions associated with a page rendered thereby.

In an embodiment the server further comprises a routing module operable to route an XML server request message received from the presentation interface through implementation of the XML stylesheet, to an database server for processing.

In an embodiment the XML server request message includes instructions for invoking business logic which is implemented in one of a data layer or middle layer of the architecture.

In accordance with a third aspect of the present invention there is provided an authentication module operable to extract authentication information from the XML server request message and communicate the authentication information to the database server for authentication prior to routing the XML server request message thereto.

In an embodiment the routing module is further operable to route XML response messages including data returned as a result of the invoked business logic to the presentation interface.

In accordance with a further aspect of the present invention there is provided a client side apparatus, the apparatus comprising: a presentation interface arranged to process an XML stylesheet to facilitate XML messaging between different logic layers of a multi-tier architecture in which the client side apparatus is operating for carrying out one or more logic functions associated with a page which is rendered by the presentation interface.

In accordance with a still further aspect of the present invention there is provided a device which is implementable by a presentation interface to facilitate XML messaging between different logic layers of a multi-tiered architecture for carrying out one or more logic functions associated with a page rendered by the presentation interface.

In an embodiment the device is an XML stylesheet.

In an embodiment the XML stylesheet is the XML stylesheet as claimed in any one of claims 1 to 12.

In accordance with a still further aspect there is provided a computer readable storage medium storing instructions that, when executed by a computer, cause the computer to perform a method for implementing an XML stylesheet in a multi-tier architecture comprising:
retrieving an XML stylesheet associated with a page to be rendered on a presentation interface;
implementing the XML stylesheet to facilitate XML messaging between different logic layers of the architecture for carrying out one or more logic functions associated with the rendered page.

In accordance with yet a further aspect there is provided a presentation interface for a client terminal operating in a multi-tier architecture, the interface comprising an XML stylesheet implementation component operable to communicate with an XML stylesheet so as to implement all event invocation and presentation layout and content functions associated with a page rendered by the interface.

In an embodiment the stylesheet implementation component is operable to communicate with the XML stylesheet by way of XML messages and XSL.

In an embodiment the XML stylesheet is loaded into memory of the client terminal for processing by the stylesheet implementation component.

In an embodiment the XML stylesheet is loaded once for each function and transformed as events are fired by the presentation interface responsive to user interactions with the rendered page.

In accordance with yet a further aspect of the present invention there is provided a method for operating a presentation interface for a client terminal operating in a multi-tier architecture, the method comprising implementing an XML stylesheet in a presentation layer of the architecture so as to implement all event invocation, presentation layout and content functions associated with a page rendered by the interface.

In an embodiment the XML stylesheet implementation component is operable to communicate with the XML stylesheet by way of XML messages and XSL.

In an embodiment the method further comprises loading the XML stylesheet into memory of the client terminal for processing by the stylesheet implementation component.

In an embodiment the method further comprises loading the XML stylesheet once for each function and transformed as events are fired by the presentation interface responsive to user interactions with the rendered page.

In accordance with a further aspect there is provided a non-transitory computer readable medium comprising a computer program which, when implemented by a computer system, is operable to implement a method as described in accordance with any one of the preceding aspects.

In the context of the present specification the term ‘web browser’ or ‘browser interface’ or ‘smart client’ are used to refer to any presentation interface that is capable of communicating with a server for viewing data on a client computer terminal.

### BRIEF DESCRIPTION OF THE DRAWINGS

Features and advantages of the present invention will become apparent from the following description of embodiments thereof, by way of example only, with reference to the accompanying drawings, in which:

FIG. 1 is a schematic of a three-tiered web architecture in accordance with an embodiment of the present invention;

FIG. 2 is a schematic illustrating flow of XML messages through the system of FIG. 1, in accordance with an embodiment; and

FIG. 3 is a process flow diagram in accordance with an embodiment.

### DETAILED DESCRIPTION OF PREFERRED EMBODIMENTS

Embodiments described herein relate to techniques for implementing XML stylesheets to orchestrate the communication between the various layers/components of a multi-tiered architecture using XML messaging. These components include, but are not limited to, a presentation interface (such as a web browser), a web server, a database server and business logic.

According to an embodiment of the invention, the XML stylesheet becomes the single point of software development at the presentation layer. The presentation interface, whether it is a web browser or smart client, performs all communication with the XML stylesheet via XML messages. The implementation and complexity of the presentation interface is hidden from the developer within the presentation interface itself. Thus, the developer no longer needs to have knowledge of the presentation implementation (such as HTML and JavaScript, Java or C++) as all presentation development, whether layout and content, event invocation, or server communication, is requested and responded to using XML messages and XSL (Extensible Stylesheet Language). The presentation interface is responsible for implementing the presentation layout and content based on XML message structures, the invocation of presentation events as XML message structures, and the server communication request response mechanism based on XML message structures. The presentation interface sends XML messages to the XML stylesheet to indicate the triggering of an event and receives XML messages from the XML stylesheet to define presentation layout and content, or request communication with the web server. The root node of the XML messages defines the type of request being made.

For the purposes of illustration, and with reference to the figures, embodiments of the invention will hereafter be described in the context of an architecture for providing multi-tiered applications accessible by way of a presentation interface which is loaded on a standard general purpose computer. According to the illustrated embodiment the presentation interface is in the form of an XML-based presentation interface, however it is to be understood that the interface could equally be a conventional HTML-based browser interface operated on any suitable client computing device, as will be described later in the detailed description.

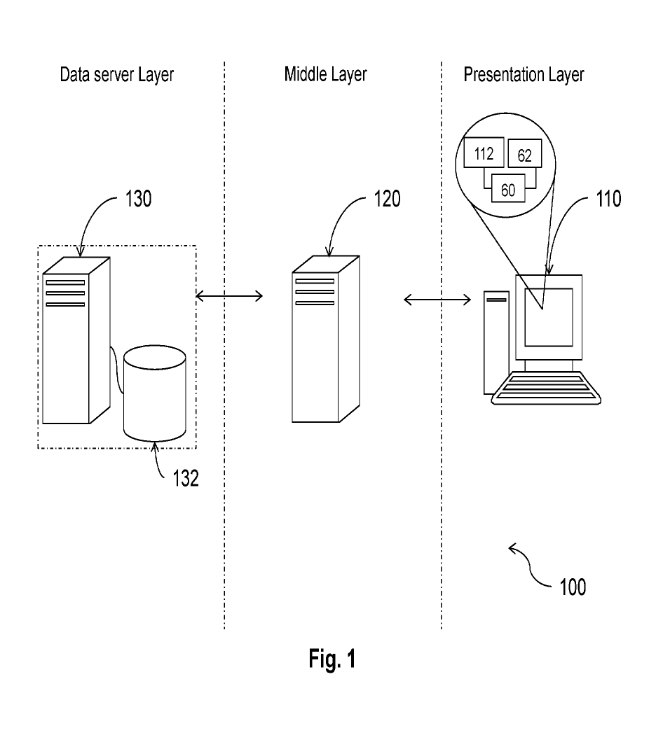

With reference to FIG. 1 there is shown an example three-tiered computing architecture 100 in which an embodiment of the invention may be implemented. Specifically, a first tier, or ‘presentation layer’, of the architecture 100 comprises a client computing device (hereafter client terminal 110) comprising a processing module 60 which operates the XML-based presentation interface (hereafter presentation interface).

In more detail, the presentation interface 112 comprises a presentation interface processing module configured to implement one or more XML stylesheets. In addition to being implemented for serving presentation views, the XML stylesheet is also advantageously implemented by the presentation interface 112 for facilitating XML messaging between different logic layers of the three-tier architecture 100 associated with data requests, or operations involving stored data items, originated by the presentation interface 112. In a particular form, the implemented XML stylesheet is programmed with logic which recognises and acts on data requests issued by the presentation interface 112 (e.g. a request, generated responsive to a user interaction with a rendered page, for a data entry stored within a database table). In response to recognising the request for data, the implemented XML stylesheet causes the presentation interface 112 to generate an XML server request message for invoking business logic (implemented in a different logic layer) to return the requested data to the presentation interface 112, as will be described in more detail below.

A middle-tier server 120 (hereafter referred to as a “web server”) is situated in the second or ‘middle’ tier and is configured to serve the XML stylesheet to the presentation interface 112 upon request. The web server 120 is also operable to route the XML messages generated by the presentation interface 112 to a database server 130 which in turn is operable to invoke the requested business logic. Correspondingly, the web server 120 routes XML server response messages (containing the requested data in XML) back to the presentation interface 112.

The web server 120 may be configured to co-operate with a particular set of client terminals 110 for accessing data stored in a particular location (e.g. client terminals for a particular company's employees that access data stored in a centralised database), or may be capable of handling requests from various client terminals for accessing data stored in multiple locations (e.g. over the Internet where the web server 120 is operable as a web server for receiving data requests from multiple client terminals).

The web server 120 is loaded with database client software which allows interaction with the database from various client platforms (e.g. Linux, Windows, Mac, etc.) on which the web server is installed. The database client software supports standard SQL statements as well as any proprietary features provided in a vendor implementation. More specifically, the database client software supports at least a database connection construct and a stored procedure execution construct (i.e. implemented in the data server layer and invoked through an XML data request as afore-described).

The database server 130 is positioned in the third tier (commonly referred to as the database layer) and is communicable with a database 132 which stores one or more tables of data required by the client device 110. Illustratively, the database 132 is an Oracle® Server database which is capable of executing stored procedures (e.g. PL/SQL or Java) for accessing the database. Positioning the business logic in the data server layer has been found to offer better security and performance than if implemented elsewhere. However, there can be valid reasons for positioning the business logic in the middle layer (e.g. implemented by a dedicated database server, web server, or the like) and embodiments are equally applicable for such an alternative configuration. In this case, persons skilled in the art will appreciate that the database need not be an Oracle database (since the business logic is not being directly invoked through the XML messaging) and instead could be any suitable data store.

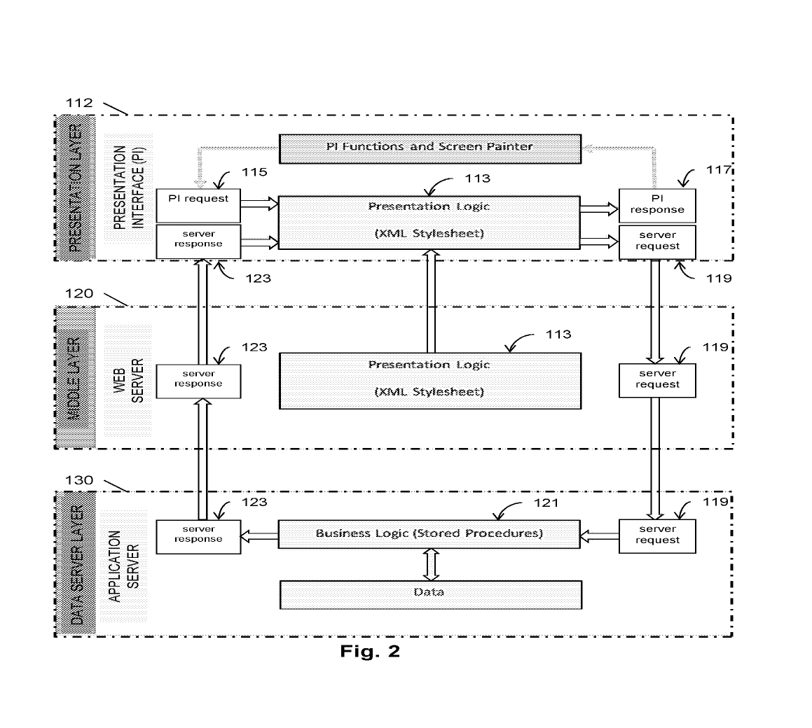

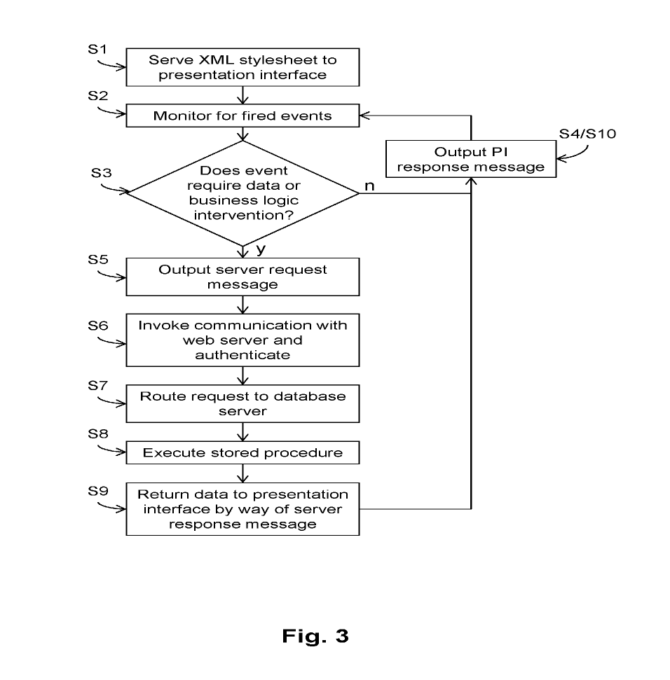

A process flow for implementing an XML stylesheet utilising the afore-described architecture will now be described with additional reference to the schematic of FIG. 2 and process flow of FIG. 3.

In a first step S1, the XML stylesheet 113 is served to the presentation interface 112 when a new screen is requested. The presentation interface 112 subsequently paints the screen and the XML stylesheet waits for a screen event to occur. Screen events are fired from the presentation interface 112 responsive to a user interaction with the painted screen (step S2). The events may, for example, be a request for data, a business logic data transformation, a screen update, or indeed any other event that the stylesheet is programmed to recognise. The events are input to the XML stylesheet by way of an XML document referred to in FIG. 2 as a PI request message 115.

The XML stylesheet 113 implements an XSL template that selects a PI request root node associated with the fired event (in this regard it is noted that the presentation interface 112 and database server 130 generate specific root nodes that the stylesheet implements as XSL templates, as will be understood by persons skilled in the art).

The XML stylesheet 113 responds to the presentation interface 112 by outputting an XML document which, depending on the nature of the event identified in the PI request 115, will take the form of either a PI response message 117 or a server request message 119, as will be described in more detail below. The determination is made in step S3.

If the event is a simple event requiring no data or business logic intervention (e.g. the user has selected a checkbox), the XML stylesheet 113 issues a PI response message 117 comprising an XML document having valid XML instructions for use by the presentation interface 112 in re-painting the screen (e.g. protecting related input based on the status of the checkbox) and completing the event (step S4).

If the event is more complex and requires either a database operation or the application of business logic, the XML stylesheet outputs a server request message 119 (step S5). The server request message 119 contains valid XML server request data together with any XML data required to execute a database stored procedure via the database server 130.

At step S6, the server request message 119 invokes communication with the web server 120 which processes the message to perform various authentication operations with the database server 130. The authentication operations may, for example, involve passing certain information extracted from the server request message 119 to the database server 130 for establishing whether the request is authentic, using techniques well understood by persons skilled in the art. Once successfully authenticated, the request message 119 is routed to the database server 130 (step S7) which in turn executes the stored procedure 121 identified in the message 119 at step S8, as will be understood by persons skilled in the art.

The database server 130 outputs a server response XML 123 (i.e. containing the data returned through the executed procedure) to the presentation interface 112, via the web server 120 (step S9). The server response 123 becomes the new input for transformation via the XML stylesheet 113. The XML stylesheet then communicates back to the presentation interface 112 by outputting an XML PI response message 117 (step S10) that incorporates the server response data into XML paint instructions.

It will be appreciated that the XML Stylesheet is loaded into memory 62 of the client computing device 110 once for each presentation interface function and is repeatedly transformed as events are fired. Thus, the XML stylesheet 113 is effectively being used as a replacement for program logic to allow presentation layer and data business logic layer to communicate via XML messaging. While templates can still be used to split the XML stylesheet 113 into efficient logic structures, designated templates are used to perform event driven communication between the interface 112 and the database server 130.

Embodiments also extend to a graphical tool for automatically creating XML stylesheets. The tool is programmed such that it enables a developer to design the layout of a screen, and all events occurring on the screen, directly on a presentation interface. In this manner the tool may automatically generate the necessary XML to populate the stylesheet, including all templates required for the layout and the necessary messaging for managing and completing specified events fired from the presentation interface. Thus, the tool can be used by business analysts or application designers who do not necessarily have any programming skills, which may greatly speed up the development process.

It is acknowledged that XML stylesheets are also used in the traditional web server environment to output a file containing both HTML and JavaScript for a standard presentation interface (such as Microsoft Internet Explorer). The reason for using XML stylesheets in this environment is similar to present embodiments in so far as it allows business data to be retrieved from the database as XML and then published to various devices via device specific XML Stylesheets. For example, the presentation interface on a mobile phone would require different HTML because of the screen size limitations. However, this is a onetime generation of the HTML and JavaScript and any subsequent event logic on the presentation interface must be implemented in the generated JavaScript, that is, any changes to the presentation layer visual components or data must be implemented using a different programming language than the programming language used to originally define it (the XML Stylesheet). Embodiments described herein encapsulate the logic within the one XML Stylesheet. The same is true for subsequent interactions with the database when using the traditional XML stylesheet approach. These interactions must be either implemented with the generated JavaScript or re-executions of the XML stylesheet back at the web server.

### Further Detail of System Configuration

It will be understood that the web server 120 and database server 130 include typical server hardware including a processor, motherboard, memory, hard disk and a power supply. The servers 120, 130 also include an operating system which co-operates with the hardware to provide an environment in which software applications can be executed. In this regard, the hard disk of the servers are loaded with software which, under the control of the processor, is operable to implement the various message and stylesheet processing functions as previously described.

It will be appreciated that the client computer 110 on which the presentation interface 112 is installed could be any suitable form of network-enabled computing device that is capable of implementing a browser interface. For example, the computing device may be a general purpose computer or a special purpose device including a smart phone, tablet, or the like. Details of such devices (e.g. processor, memory, display, data storage, etc.) are omitted for the sake of clarity. Where the special purpose device is a smart client device such as a mobile phone, an application may be downloaded by the device for generating and receiving the XML request/response messages (as afore-described). Further, it will be understood that the connection to the network by the smart client device may be by way of an intermediate network (e.g. mobile phone gateway). For the embodiment illustrated in FIG. 1, the client terminal 10 takes the form of a general purpose computer comprising an operating system which co-operates with the hardware to provide an environment in which software applications can be executed. In this regard, the hard disk of the client terminal 110 is loaded with a processing module 60 which, under the control of the processor, is operable to implement the presentation interface 112 which is in turn operable to process a stylesheet 113 for performing the various paint and messaging functions as afore-described.

It will be understood that other standard and/or non-standard modules for the aforementioned computing devices, 110, 120, 130 may also be implemented for carrying out operation of paint, messaging and authentication functionality as afore-described. Further, it will be understood that the term “processor” as used herein is to be construed broadly and include within its scope any device that can process the relevant data/messages and may include a microprocessor, microcontroller, programmable logic device or other computational device, a general purpose computer, or a server computer.

A number of advantages arise through the use and implementation of XML stylesheets in accordance with embodiments described herein. Most notably, using a single XML document to define the layout of screens as well as to manage the events occurring on the screen greatly reduces the amount of code required from the developer for the presentation layer. Additionally, the use of XML messaging for communication between components, rather than simple text strings (i.e. as for conventional methodologies), allows components to perform many functions normally coded by the developer, again reducing the amount of code required from the developer. Importantly, these dramatic improvements in productivity are achieved using standard, commonly-used programming languages such as Java and PL/SQL for the business logic.

Further specific advantages of embodiments include:
Cost savings by reducing the amount of in-house written code by a developer
Eliminating the physical communication layer between business analysts and IT programmers, and the required skill and unit resource cost, by enabling business analysts to design and create screens
automating the process of creating and displaying screens thereby eliminating errors that may occur at the presentation layer
allows for business logic to be written in any XML compatible programming language that is supported by the database being used by the application
providing an environment in which software can be quickly created and maintained to meet changing market conditions
providing an architecture that allows application to scale rapidly if required
ensuring that scarce and expensive IT resources spend more of their time on important business logic rather than on ‘infrastructure’ areas that do not provide competitive advantage
creating multi-tiered applications that enable customers and staff to access business data—and to transact—via the Internet at all times and anywhere in the world
providing a separation of presentation and business logic layers that allows (a) emerging presentation interfaces (mobile phones, tablets, etc.) to be introduced quickly and easily and (b) simple screen changes (e.g. re-arranging where something is displayed) to be made without affecting business logic and without requiring programmer intervention
facilitating the quick and easy introduction of new spoken languages and ‘cultures’ (e.g. currency formats) for international rollouts and installations.

While the invention has been described with reference to the present embodiment, it will be understood by those skilled in the art that alterations, changes and improvements may be made and equivalents may be substituted for the elements thereof and steps thereof without departing from the scope of the invention. In addition, many modifications may be made to adapt the invention to a particular situation or material to the teachings of the invention without departing from the central scope thereof. Such alterations, changes, modifications and improvements, though not expressly described above, are nevertheless intended and implied to be within the scope and spirit of the invention. Therefore, it is intended that the invention not be limited to the particular embodiment described herein and will include all embodiments falling within the scope of the independent claims.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1-30. (canceled)

31. A method for implementing an XML stylesheet in a multi-tier architecture, the method comprising:
retrieving an XML stylesheet associated with a page for rendering on a presentation interface;
implementing the XML stylesheet to control XML messaging between different logic layers of the architecture for carrying out one or more logic functions associated with the page.

32. A method according to claim 31, further comprising implementing the XML stylesheet to additionally provide page content for rendering by the presentation interface.

33. A method according to claim 32, further comprising implementing the XML stylesheet to additionally determine a presentation layout for the page content.

34. A method according to claim 31, further comprising serving the XML stylesheet to the presentation interface by a web server which stores the XML stylesheet.

35. A method according to claim 34, wherein the XML stylesheet is implemented to control XML messaging between a presentation layer, middle layer and data layer of the web server architecture.

36. A method according to claim 35, wherein the XML stylesheet is implemented in the presentation layer by the presentation interface to initiate XML messaging between the different layers for retrieving and/or updating data from/in a database, responsive to a predefined user interaction with the rendered page.

37. A method according to claim 36, wherein the XML stylesheet is implemented to recognise the predefined user interaction and, in response thereto, instruct the presentation interface to generate an XML server request message for processing by a server in order to retrieve/update the data.

38. A method according to claim 37, wherein the XML server request message is operable to cause the server to invoke business logic which is implemented in the data layer for retrieving and/or updating the data.

39. A method according to claim 37, wherein the XML server request message is operable to cause the server to invoke business logic which is implemented by a server operating in the middle layer for retrieving and/or updating the data.

40. A method according to claim 38, wherein the server is configured to assemble data retrieved as a result of the invoked business logic in an XML server response message which is sent back to the presentation interface for re-rendering the page.

41. A method according to claim 35, wherein the XML server request/response messages are routed by way of a web server.

42. A method according to claim 41, further comprising extracting authentication information from the XML server request message for authentication by the server prior to invoking the business logic.

43. A computer server operable in a multi-tier architecture and comprising a stylesheet serving module configured to serve an XML stylesheet to a presentation interface responsive to receiving a request message from the presentation interface, the presentation interface being operable to implement the XML stylesheet in order to control XML messaging between different logic layers of the architecture for carrying out one or more logic functions associated with a page rendered thereby.

44. A computer server in accordance with claim 43, further comprising a routing module operable to route an XML server request message received from the presentation interface through implementation of the XML stylesheet, to an database server for processing.

45. A computer server in accordance with claim 44, wherein the XML server request message includes instructions for invoking business logic which is implemented in one of a data layer or middle layer of the architecture.

46. A computer server in accordance with claim 45, further comprising an authentication module operable to extract authentication information from the XML server request message and communicate the authentication information to the database server for authentication prior to routing the XML server request message thereto.

47. A computer server in accordance with claim 45, wherein the routing module is further operable to route XML response messages including data returned as a result of the invoked business logic to the presentation interface.

48. A client side apparatus, the apparatus comprising: a presentation interface arranged to process an XML stylesheet to control XML messaging between different logic layers of a multi-tier architecture in which the client side apparatus is operating for carrying out one or more logic functions associated with a page which is rendered by the presentation interface.

49. A stylesheet which is implementable by a presentation interface to control XML messaging between different logic layers of a multi-tiered architecture for carrying out one or more logic functions associated with a page rendered by the presentation interface.

50. A presentation interface for a client terminal operating in a multi-tier architecture, the interface comprising an XML stylesheet implementation component operable to communicate with an XML stylesheet so as to implement all event invocation and presentation layout and content functions associated with a page rendered by the interface.
